(19) United States
(12) Patent Application Publication
(10) Pub. No.: US 2007/0278758 A1
(43) Pub. Date: Dec. 6, 2007

(54) Avalanche skateboard

(76) Inventor: No Un Kwak, Alexandria, VA (US)

Correspondence Address: Steven Kreiss;Attorney at Law, Suite 240, 1120 Connecticut Avenue, N.W., Washington, DC, 20036, US

(21) Appl. No.: 11/445,182

(22) Filed: Jun. 2, 2006

(51) Int. Cl. B62M 1/00

(52) U.S. Cl. 280/87.042

(57) ABSTRACT

A skateboard apparatus wherein an attached front wheel rotatable to predetermined limits through use of a stop mechanism assists the user in determining the direction of the skateboard. One or more rear wheels connected to, and whose location is adjustable on, said skateboard rotates unidirectionally frontward or backward, and a brake system attached to the underside of said platform may be used to retard the speed of said skateboard.

### BACKGROUND OF THE INVENTION

The Avalanche Board invention relates to skateboards, roller boards, ski boards or the like for carrying persons from one destination to another through use of said boards. Skateboards, roller boards and/or ski boards and their use have been well known in the prior art. These boards may have a single integral platform onto which the user may step or the platform may be divided into separate, but connected platforms, with each foot, or one of them, resting upon a separate platform. In the case of either the single platform or two-part platforms, wheels are mounted on the underside of said platform or platforms in order to propel the user forward by a push or pushes on the ground from the user.

If the board wheels are fixed and rotate in only one direction, then in order for the user to turn the board, he will be required to raise the front end of the board to swivel and turn direction. In some boards, casters are used as wheels, and these casters can rotate in different directions and thus change the direction of the board without having to raise the front end thereof. Pressure from the user's legs provides the required torque to propel and turn the board after an initial push. Regardless of whether a single or double platform configuration is used with either wheel configuration noted above, these prior art boards require their users to constantly push on the ground with their feet to obtain power and movement. In contrast, the present Avalanche board invention permits users to simply use their body movements to obtain power and movement, after an initial push by foot or ski poles, without having to continuously push themselves with their feet touching the ground.

### SUMMARY OF THE INVENTION

The Avalanche board invention relates to boards wherein all its components are made of durable materials such as wood or polyurethane. Different materials may be used to construct the board depending upon the user's choice. For example, the board user may desire a lightweight board to be constructed substantially of polyurethane. Another board user may desire that his board be heavier and thus substantially made from wood. The invention is easily manufactured from different materials depending upon the user's preference and/or skill level. The movement required to propel the Avalanche board requires muscle activation in the shoulders, arms, abdomen and/or legs, especially when traveling uphill. Once the user finds his balance on the board, he may use ski poles to provide that initial push to propel the board in the desired direction. When traveling downhill or uphill, the Avalanche board permits the user to turn as a result of a front wheel which rotates in different directions up to a predetermined limit imposed upon said wheels by a limiting stop mechanism. Depending upon the weight or size of the user, the size of the board can be changed. For example, users less than 160 pounds may find it advantageous to use a 15 inch wide by 18 inch length board whereas for users over 160 pounds, a 17 inch wide by 22 inch length board may be more advantageous.

The inventive Avalanche board may have one platform with designated foot placement areas functioning in such a way for easy mounting and thrust from an initial push on the ground by the user. Once the initial thrust is made by the user, the user may propel the board without removing his feet from the board. The board may have a front wheel and rear wheels. The rear wheels are stationary, rotate in one direction (forward and back) and are aligned with respect to the center of the board. The front wheel rotates at different angles to allow for turning motions. A stop is attached to the board adjacent the front wheel to prevent the front wheel from rotating in directions greater than 180 degrees. If the 180 degree rotation of the front wheel is exceeded, the board can stop suddenly creating a dangerous, unsafe condition. Depending upon the placement of the stop mechanism, the front wheel can rotate up to 80 degrees on each side from its centerline position. Thus, the maximum rotation for the front wheel in the preferred embodiment is 160 degrees. The front wheel stop system can be made of strong materials like wood, steel, aluminum or polyurethane.

A brake system is placed on the underside of the board on both the right and left edges. The user can easily lean to the right or left to create a smooth stop and prevent injury. The brake system may be made from rubber, plastic, PVC or wood. The vertically aligned position of the front wheel is slightly off from the centerline of the board and must be pointing toward the rear, as distinguished from the front, of the board. If the front wheel is initially pointing to the front of the board, the board may not move in any desired direction. The same size wheels can be used for both the front and rear wheels. When the front wheel is slightly larger than the rear wheels, however, the board has better handling and smoother movement. The momentum from the user's initial thrust from the ground, as well as his subsequent body movement, provides the necessary propulsion to maintain the board's movement.

There are multiple variations of rear wheel placement. A two wheel wide version may be used by users with a beginner's skill level. In the preferred embodiment, the two rear wheels, when separated to their maximum length as determined by holes in the board, provide increased stability. A narrow two rear wheel configuration is also an option for users with a skill level beyond the beginner level. Users can adjust the space between rear wheels by simply unscrewing the rear wheels and placing them in holes contained within the board for such adjustment purposes. Users with an expert skill level may utilize a board with one rear wheel to perform tricks such as jumps and/or to increase the speed at which the board travels. Holes are provided in the board for this alternate embodiment. In this configuration, two removable straps, not shown, may be affixed to the board to secure the feet and balance of the user. In order to facilitate the turning or nonlinear motion of the inventive board, the user can shift his weight on his feet and rotate the front wheel of the board to the desired position consistent with the stop mechanism in order to perform the desired turning function. As for the ski poles, any type of pole can be used, depending upon the user's preference. No other board prior to the inventive one described herein contains all the above features necessary for the stable linear and nonlinear board motion described above.

In summary, the salient features of the inventive skateboard are: (a) a platform containing a rotatable front wheel capable of turning the board to a limit to enable safe turns while the board is in motion, (b) a stop mechanism permitting the board to turn in a safe manner, (c) a brake system to enable the user to stop the board's motion when desired, and (d) an adjustable one or two rear wheel configuration to obtain a performance of the board desired by the user consistent with his skill level.

### BRIEF DESCRIPTION OF THE DRAWINGS

FIG. 1 is a top elevation view of the inventive board.

FIGS. 2A and 2B are bottom views of two rear wheel versions of the inventive board.

FIG. 2C is a bottom view of a one rear wheel version of the inventive board.

### DESCRIPTION OF THE DRAWINGS

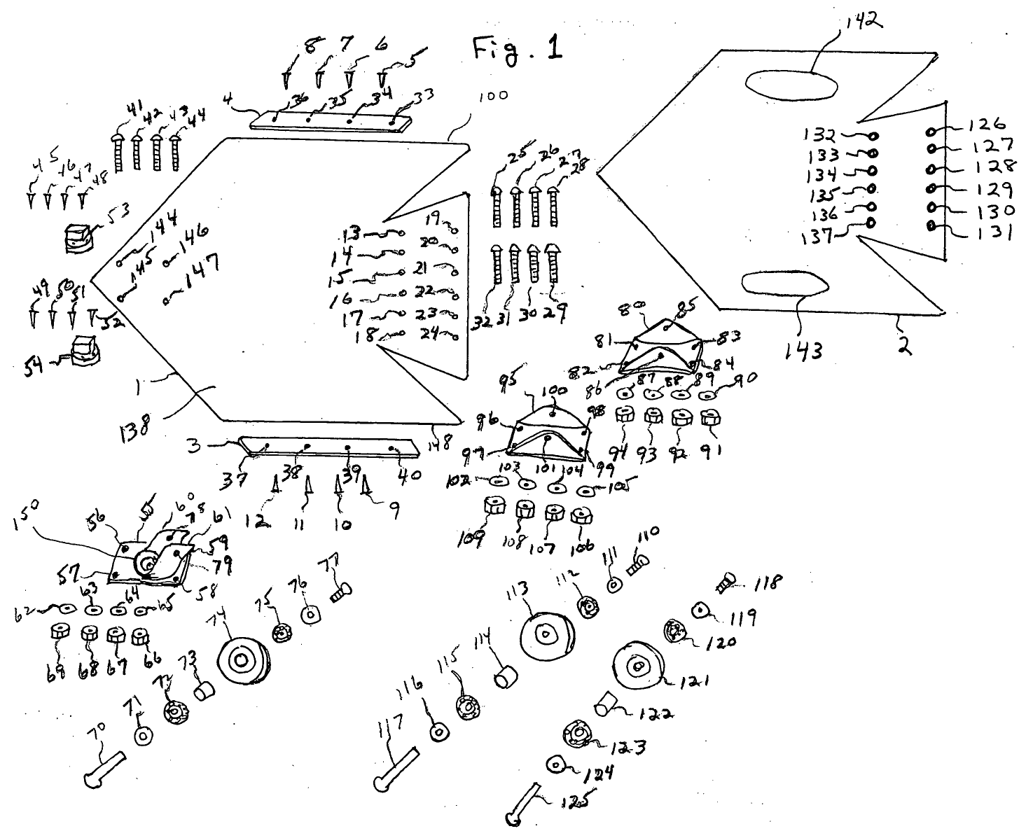

The skateboard 1 shown in FIG. 1 contains a top side 138. Covering the board's top side 138 is a sandpaper or rubber surface 2 containing holes 126-137, which may be used to fasten rear wheels 113, 121 to the skateboard 1. Although twelve holes 126-137 are provided in board 1, each rear wheel may use only four such holes. Thus, the holes 126-137 are provided to permit the user to adjust the spacing between the rear wheels or to permit a one rear wheel configuration if desired by the user. Foot surfaces 142 and 143 are provided on surface 2 in order for a user to place his feet to operate the skateboard 1. Surface 2 also protects the top 138 of the board 1 and surfaces 142, 143 provide rough or highly frictional surfaces to prevent the user's feet from slipping from the board 1. Skateboard 1 also contains brakes 3, 4 attached to the underside of side edges 100, 148 of board 1. Brakes 3, 4 each contain four holes 33-36 and 37-40 into which screws 5-8 and 9-12 are driven to attach brakes 3, 4 to the board 1. Brakes 3, 4 permit the board's user to stop or retard the motion or acceleration of the board 1.

Board 1 contains holes 13-24 located on the rear side of said board. These holes align with holes 126-137 on surface 2. On the front side of the board 1 there is contained four holes 144-147. A front wheel mount 55 is attached to the underside of board 1 by virtue of holes 56-59, which mate with holes 144-147, corresponding bolts 41-44, washers 62-65 and nuts 66-69. Front wheel mount 55 contains rotating collars 60, 61 which are attached to a rotatable bearing affixed to said front wheel mount 55. Rotating collars 60, 61 have holes 78, 79 which are used to attach a wheel and shaft to said collars. Front wheel 74 is attached to collars 60, 61 by virtue of wheel shaft 70, bushings 71, 76, bearings 72, 75, liner 73 and ranch bolt 77. The rotation of collars 60, 61 is limited by stops 53, 54 which are attached to the underside of the board 1 by screws 45-48 and 49-52 respectively. Stops 53, 54 create a stop mechanism to prevent the front, rotatable wheel 74 from rotating more than 160 degrees or up to 80 degrees on both sides of the initial vertical position of collars 60, 61. Stops 53, 54 can be made of strong materials like steel, aluminum, or polyurethane. The vertically aligned position of the front wheel mount 55 is slightly off from the centerline of board 1 and must also be pointing to the rear of the board 1 in order to permit board 1 movement if desired.

A rear wheel mount 95 is attached to the underside of the rear side of board 1. Rear wheel mount 95 contains four holes 96-99 which align with holes 17,18,23,24 on board 1 if the user so desires. Ranch bolts 29-32 fit through rear mount holes 96-99 and 17,18,23,24 and attach rear wheel mount 95 to board 1 through washers 102-105 and nuts 106-109. Rear wheel 113 is mounted upon wheel mount 95 through wheel shaft 117, bushings 116,111, bearings 115,112, liner 114, and bolt 110.

Similarly, a rear wheel mount 80 is attached to the underside of the rear portion of board 1. Rear wheel mount 80 contains four holes 81-84 which align with holes 13,14,19,20 on board 1. Ranch bolts 25-28 fit through holes 81-84 and 13,14,19,20 and attach rear wheel mount 80 to board 1 through washers 87-90 and nuts 91-94. Rear wheel 121 is mounted upon wheel mount 80 through wheel shaft 125, bushings 124,119, bearings 123,120, liner 122, and bolt 118. Rear wheels 113, 121, as distinguished from front wheel 74, rotate in one direction, front or back.

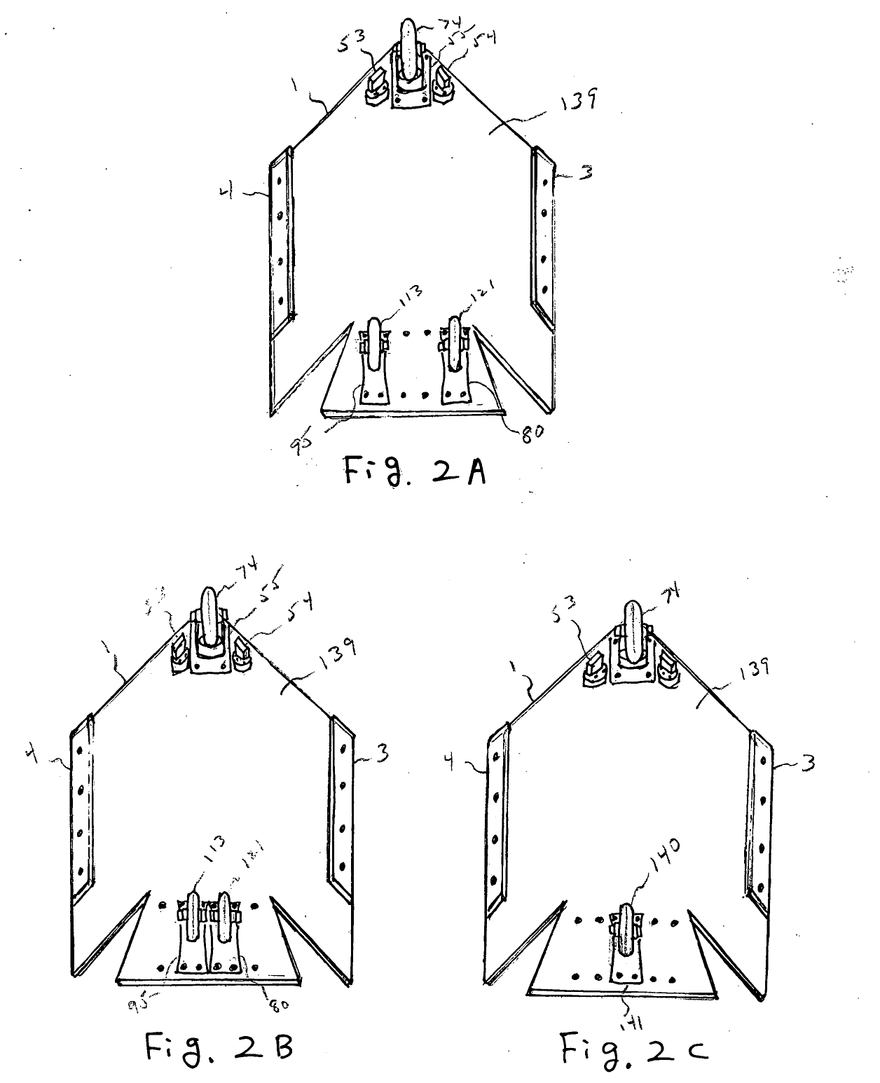

FIG. 2A illustrates more clearly the manner by which the front wheel mount 55, stops 53, 54, brakes 3, 4, and rear wheel mounts 80, 95 are mounted to the underside 139 of board 1. Wheel 74 is capable of turning in FIGS. 2A-2C by virtue of collars 60, 61 turning until said collars engage either stop 53 or 54, at which point wheel 74 and board 1 may not turn any further in said direction. Brakes 3, 4, also shown in FIGS. 2A-2C are located on the sides of board 1 adjacent the front and rear sides wherein said wheels 74, 113 and 121 are located. FIG. 2A illustrates the widest spacing between rear wheel mounts 80 and 95, and FIG. 2B illustrates the narrowest spacing between said rear wheel mounts. FIG. 2C illustrates a one rear wheel 140 configuration whereby the rear wheel mount 141 is attached to the center holes 15, 16, 21, 22 shown in FIG. 1.

What I claim is:

1. A skateboard comprising:
(a) a platform having at least a front, rear, two sides, an upper side and an underside;
(b) a front wheel mount attached to the underside of the front of said platform;
(c) a rotatable means attached to said front wheel mount for rotating in different directions a wheel connected to said means and permitting said wheel to place the skateboard in motion in different directions;
(d) a stop means for preventing rotation of the rotatable means beyond a predetermined limit;
(e) a plurality of rear wheel mounts attached to the rear of the platform; and
(f) a plurality of wheels connected to said rear wheel mounts which rotate in only one direction.

2. The skateboard of claim 1 wherein the rotatable means comprises a rotatable bearing and collars attached to said front wheel mount.

3. The skateboard of claim 2 further comprising a means to adjust the length between the rear wheel mounts.

4. The skateboard of claim 1 further comprising a brake means for retarding the motion of said platform.

5. The skateboard of claim 1 further comprising a means for covering the upper side of said platform, said means further comprising two rough surfaces for preventing a user from falling off the board.
